(19) United States
(12) Patent Application Publication
(10) Pub. No.: US 2002/0073509 A1
(43) Pub. Date: Jun. 20, 2002

(54) Mechanism and method for adjusting doors

(75) Inventor: Patrick M. Dean, Issaquah, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: PACCAR Inc.

(21) Appl. No.: 09/738,170

(22) Filed: Dec. 14, 2000

(51) Int. Cl. E05D 5/02; E05D 7/04

(52) U.S. Cl. 16/387

(57) ABSTRACT

An adjustable hinge system for coupling a first element to a second element is provided. The system includes a first hinge leaf defining a horizontal slot and a vertical slot, which is to be coupled to the first element, and a second hinge leaf to be coupled to the second element. The system also includes first and second eccentric fasteners, each including a head portion and a shaft portion, wherein the shaft portion extends off-axis from the head portion. The first eccentric fastener extends through the horizontal slot into the first element, with its head portion being fitly received within the horizontal slot and the shaft portion being rotatably received in the first element. Similarly, the second eccentric fastener extends through the vertical slot into the first element. Turning the head portion of the first or second eccentric fastener moves the first hinge leaf (and hence the second element) vertically or horizontally, respectively, relative to the first element.

### FIELD OF THE INVENTION

The present invention is directed to a mechanism and method for adjusting the relative position of two elements that are hinged together, and more particularly, to a mechanism and method that allow for independent vertical and horizontal adjustments of two elements.

### BACKGROUND OF THE INVENTION

Currently, there are two general methods of door adjustment, used for example in the heavy truck manufacturing industry, in installing a door to a door frame. First, door adjustment is done by manually deforming either or both of the door and the door frame so that the door appears to be oriented correctly in the door frame with appropriate body gaps. This is a time-consuming and skill-based method, which often results in poor seal performance and unintentional damage to the structure. Second, door adjustment is done by using hinges with oversized holes defined therethrough, which allow the relative position of the hinges and the door, and hence the door frame to the door, to be readjusted. This second method requires that a fixture be used to hold the door in position while the hinge bolts are adjusted within the oversized holes to desired positions and fastened. Guaranteeing that the door will be in the proper position, once the hinge bolts are fastened and the supporting fixture is removed, is very difficult and requires diligence on the part of the assembly workers to make sure that all variations in the related parts are accounted for. Adjusting the door without the help of the fixture, as is sometimes required due to unforeseeable tolerance issues, is also very difficult. A need exists for a simple and reliable method and system for adjusting a door in a door frame.

### SUMMARY OF THE INVENTION

The present invention provides an adjustable hinge system for coupling a first element (a door, for example) to a second element (a door frame, for example), wherein the relative position of the first and second elements can be freely adjusted. The hinge system includes a first hinge leaf defining a horizontal slot and a vertical slot, which extend orthogonally with each other. The first hinge leaf is adapted to be coupled to the first element. The hinge system further includes a second hinge leaf pivotally coupled to the first hinge leaf. The second hinge leaf is adapted to be coupled to the second element. The hinge system still further includes a first eccentric fastener including a head portion and a shaft portion, wherein the shaft portion extends off-axis from the head portion. The head portion is sized to be fitly received in the horizontal slot in the first hinge leaf. The hinge system also includes a second eccentric fastener including a head portion and a shaft portion that extends off-axis from the head portion. The head portion of the second eccentric fastener is sized to be fitly received in the vertical slot.

In operation, the first hinge leaf is coupled to the first element by the first eccentric fastener extending through the horizontal slot into the first element, with its head portion being fitly received within the horizontal slot and the shaft portion being rotatably received in the first element. Also, the second eccentric fastener extends through the vertical slot into the first element, with its head portion being fitly received within the vertical slot and the shaft portion being rotatably received in the first element. In this arrangement, turning the head portion of the first eccentric fastener within the horizontal slot moves the first hinge leaf vertically relative to the first element, and turning the head portion of the second eccentric fastener within the vertical slot moves the first hinge leaf horizontally relative to the first element. Thus, the hinge system of the present invention allows for the relative position of the hinge system and the first element, and hence the second element fixedly coupled to the hinge system and the first element, to be adjusted in both horizontal and vertical directions. The adjustment is smooth and repeatable, and the horizontal and vertical adjustments can be performed independently from each other.

In one aspect, the second hinge leaf of the hinge system may also define a second vertical slot. The hinge system still further includes a third eccentric fastener including a head portion and a shaft portion, wherein the shaft portion extends off-axis from the head portion. In use, the second hinge leaf is coupled to the second element by the third eccentric fastener extending through the second vertical slot into the second element, with its head portion being fitly received within the second vertical slot and the shaft portion being rotatably received in the second element. In this arrangement, turning the head portion of the third eccentric fastener causes the horizontal movement of the second hinge leaf relative to the second element. When the second hinge leaf is arranged orthogonally to the first hinge leaf, turning the third eccentric fastener causes the movement of the second hinge leaf relative to the second element in a direction that is perpendicular to the plane of the first hinge leaf. Thus, in this embodiment, the hinge system of the present invention allows for three dimensional adjustments of the relative position of the first and second elements.

The present invention further provides a method of adjusting the relative position of the first and second elements that are pivotally coupled together by a hinge including first and second hinge leaves. First, a horizontal slot and vertical slot are defined either through the first element or through the first hinge leaf. A first eccentric fastener including a head portion and a shaft portion, wherein the shaft portion extends off-axis from the head portion, is inserted through the horizontal slot. At this point, the head portion of the first eccentric fastener is fitly received within the horizontal slot and the shaft portion is rotatably received in either the first element or the first hinge leaf that does not define the horizontal slot. A second eccentric fastener including a head portion and a shaft portion is inserted through the vertical slot, with its head portion being fitly received within the vertical slot and the shaft portion being received in either the first element or the first hinge leaf that does not define the vertical slot. In this arrangement, turning the head portion of the first eccentric fastener within the horizontal slot causes the vertical movement of the first hinge leaf relative to the first element. Further, turning the head portion of the second eccentric fastener within the vertical slot causes the horizontal movement of the first hinge leaf relative to the first element.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 illustrates a hinge system including a hinge leaf defining vertical and horizontal slots therethrough, formed in accordance with the present invention;

FIG. 2 is an eccentric fastener suitable for use in the present invention; and

FIGS. 3A and 3B illustrate a hinge system of the present invention in operation, showing horizontal adjustment to the right and to the left, respectively, of the hinge system.

### DETAILED DESCRIPTION OF THE PREFERRED EMBODIMENT

The present invention provides a system and method for adjusting the relative position of two elements that are hinged together, which allow for repeated and independent adjustments in both horizontal and vertical directions (two-dimensional adjustments). Additionally, in one embodiment, a hinge system allows for three-dimensional adjustments of the relative position of two elements.

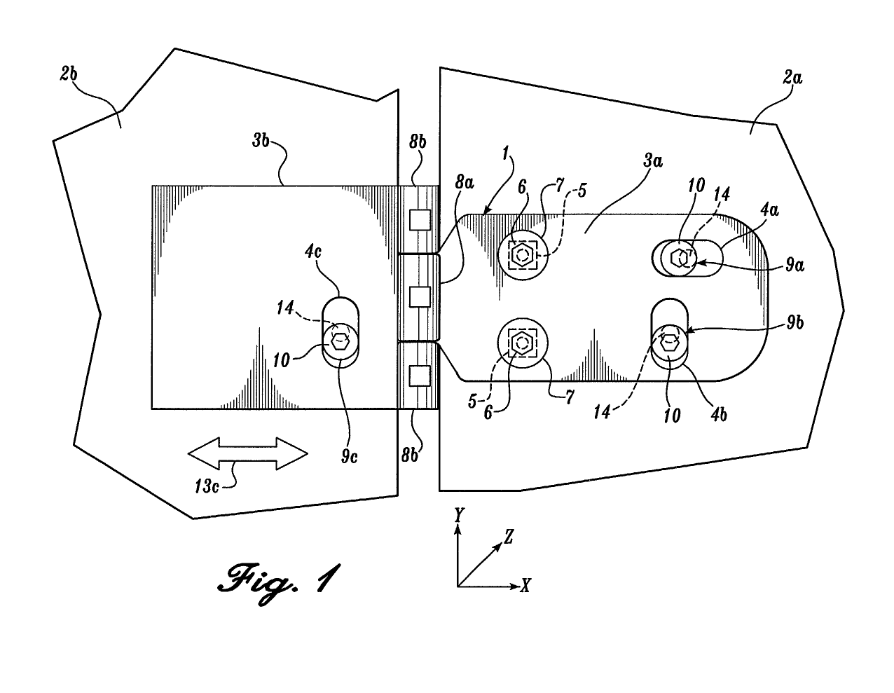

FIG. 1 illustrates one embodiment of an adjustable hinge system 1 for coupling a first element 2a, for example a door, and a second element 2b, for example a door frame, formed in accordance with the present invention. The hinge system 1 includes a first hinge leaf 3a that defines a horizontal slot 4a and a vertical slot 4b. The horizontal slot 4a and the vertical slot 4b extend orthogonally with each other. The first hinge leaf 3a is adapted to be coupled to the first element 2a. For example, the first hinge leaf 3a may include one or more oversized apertures 5. By extending a bolt 6 through a washer 7, the oversized aperture 5, and the first element 2a, and securing a distal end of the bolt 6 on the other side (the reverse side of the plane of FIG. 1) using a nut (not shown), one may secure the first hinge leaf 3a to the first element 2a. As used in the prior art, the oversized aperture 5 allows for repositioning the bolt 6, after it is extended through and secured to the first element 2a, with respect to the first hinge leaf 3 a prior to securely fixating the first hinge leaf 3a to the first element 2a. This feature is advantageous in permitting the hinge system 1 of the present invention to freely and accurately adjust the relative position of the first hinge leaf 3a and the first element 2a, as more fully described below.

The second hinge leaf 3b is hinged to or pivotally coupled to the first hinge leaf 3a, in any conventional manner, for example by providing mating hollow knuckles 8a and 8b on the first and second hinge leaves 3a and 3b, respectively, and inserting a pin (not shown) therethrough. The second hinge leaf 3a is adapted to be coupled to the second element 2b, using any suitable means.

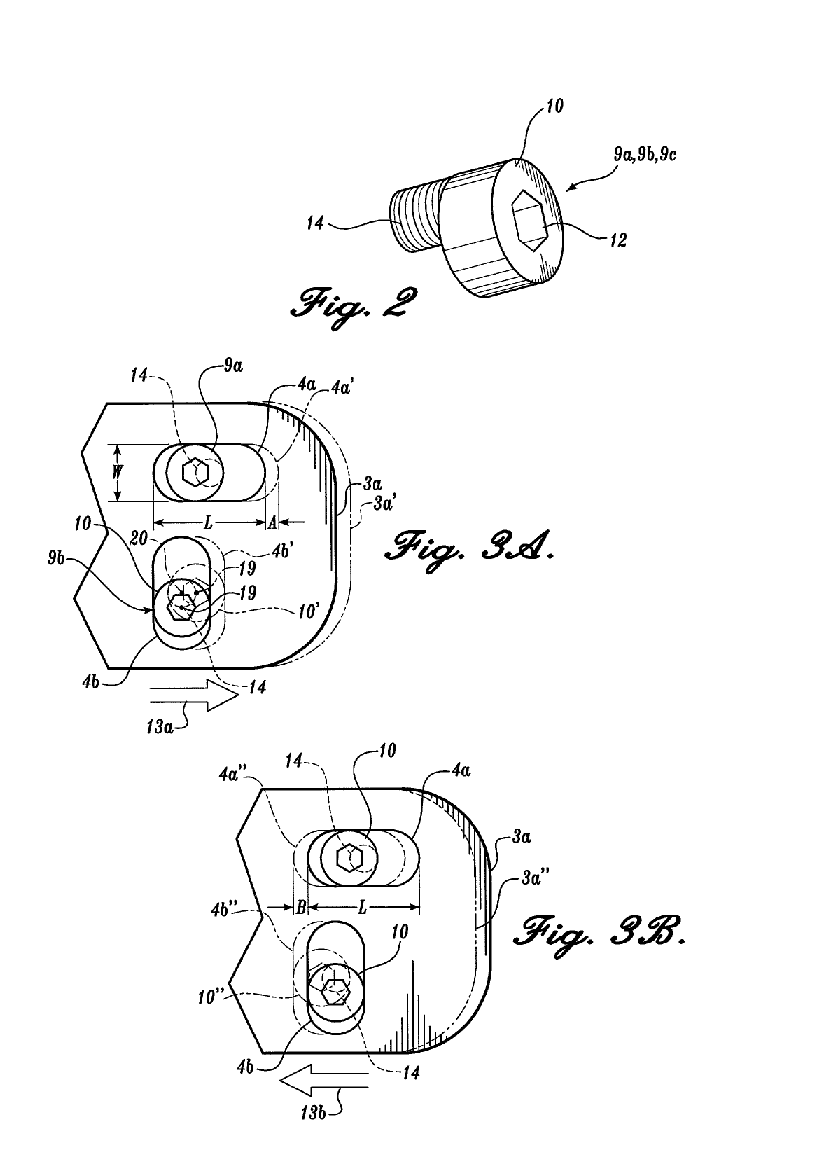

Referring additionally to FIG. 2, the hinge system 1 further includes a first eccentric fastener 9a including a head portion 10 and a shaft portion 14 that extends off-axis from the head portion 10. The head portion 10 of the first eccentric fastener 9a is sized to be fitly received in the horizontal slot 4a. In the present description, the term “fitly” is used to describe that the head portion 10 is snugly received within a slot, with a tolerance therebetween as close as possible so that the head can rotate within the slot without biting the slot. The hinge system 1 also includes a second eccentric fastener 9b, which includes a head portion 10 and a shaft portion 14 that extends off-axis from the head portion 10. The head portion 10 of the second eccentric fastener 9b is sized to be fitly received in the vertical slot 4b. As illustrated, the head portion 10 of the eccentric fasteners 9a or 9b is generally circular, and includes means for applying torque. For example, the illustrated eccentric fastener defines a female socket 12 for receiving an Allen wrench therein for this purpose. The shaft portion 14 is adapted to be rotatably received within the first element 2a or the second element 2b using any suitable means. For example, the shaft portion 14 may be provided with threads, as shown in FIG. 2, or may be secured to the first or second elements 2a, 2b by using a nut or nut plate (not shown).

In use, the first hinge leaf 3a is coupled to the first element 2a using the first eccentric fastener 9a extending through the horizontal slot 4a into the first element 2a. At this point, the head portion 10 of the first eccentric fastener 9a is fitly received within the horizontal slot 4a and the shaft portion 14 thereof is rotatably received in the first element 2a. Similarly, the second eccentric fastener 9b extends through the vertical slot 4b into the first element 2a. The head portion 10 of the second eccentric fastener 9b is fitly received within the vertical slot 4b and the shaft portion 14 thereof is rotatably received in the first element 2a.

Referring to FIGS. 3A and 3B, operation of the hinge system 1 to effect horizontal adjustment is described. In FIG. 3A, when the head portion 10 of the second eccentric fastener 9b is turned about its shaft portion 14 counterclockwise, the head portion 10′ pushes against the right-hand side of the vertical slot 4b to move the vertical slot to a new position 4b′. Thus, the first hinge leaf 3a is horizontally moved to a position 3a′, in a direction indicated by an arrow 13a, with respect to the first element 2a that is represented by the plane of FIG. 3A. During this time, the first eccentric fastener 9a remains in the original position while the horizontal slot 4a is moved to the right to a new position 4a′. In effect, the first eccentric fastener 9a and the horizontal slot 4a in combination serve to maintain the vertical position of the first hinge leaf 3a with respect to the first element 2a intact, so that adjustment using the second eccentric fastener 9b and the vertical slot 4b is in a horizontal direction only. Similarly, in FIG. 3B, when the head portion 10 of the second eccentric fastener 9b is turned about its shaft portion 14 clockwise, the head portion 10″ pushes against the left-hand side of the vertical slot 4b to move the vertical slot 4b to a new position 4b″, and hence the first hinge leaf 3a to a new position 3a″ in a direction indicated by an arrow 13b. During this time, the first eccentric fastener 9a again remains in the original position while the horizontal slot 4a is moved to the left to a position 4a″, to maintain the vertical orientation of the first hinge leaf 3a with respect to the first element 2a intact.

FIGS. 3A and 3B describe the movement of the first hinge leaf 3a through 180° rotation of the head portion 10 of the second eccentric fastener 9b. As will be apparent to those skilled in the art, another 180° rotation of the second eccentric fastener 9b produces the same horizontal displacement of the first hinge leaf 3a with respect to the first element 2a. Also as will be apparent to those skilled in the art, turning the first eccentric fastener 9a within the horizontal slot 4a moves the horizontal slot 4a, and hence the first hinge leaf 3a, vertically with respect to the first element 2a. During this time, the second eccentric fastener 9b remains in the same position as the vertical slot 4b is shifted vertically so as to maintain the horizontal orientation of the first hinge leaf 3a with respect to the first element 2a.

Referring back to FIG. 1, in one embodiment, the second hinge leaf 3b may also define a second vertical slot 4c. A third eccentric fastener 9c constructed in the same manner as the first and second eccentric fasteners 9a and 9b is inserted therethrough, with its head portion 10 fitly received in the second vertical slot 4c and its shaft portion 14 rotatably received in the second element 2b. As before, turning the head portion 10 of the third eccentric fastener 9c within the second vertical slot 4c moves the second vertical slot 4c, and hence the second hinge leaf 3b, horizontally relative to the second element 2b, as indicated by an arrow 13c. When the plane of the second hinge leaf 3b is arranged perpendicularly (y-z plane) to the plane of the first hinge leaf 3a (x-y plane), turning the head portion 10 of the third eccentric fastener 9c causes “in-out” movement (with respect to the plane of FIG. 1), i.e., movement of the second hinge leaf 3b along the z direction relative to the second element 2b. At this time, the first and second eccentric fasteners 9a and 9b remain within the horizontal and vertical slots 4a and 4b, respectively, so as to maintain the orientation of the second hinge leaf 3b in both x and y directions with respect to the second element 2b. Thus, in this embodiment, one can adjust the relative position of the first element 2a and the second element 2b three-dimensionally, in all x, y, and z directions independently by turning the first, second, and third eccentric fasteners 9a, 9b, and 9c, respectively.

The dimensional aspects of the hinge system 1 are now described. Referring to FIGS. 3A and 3B, each of the horizontal and vertical slots 4a and 4b includes a length dimension L and a width dimension W. Further, in the illustrated embodiment, the head portion of each eccentric fastener is made circular. The width dimension W of each slot is sized to generally match the diameter of the circular head portion of the corresponding eccentric fastener. The length dimension L of the horizontal slot 4a is at least the diameter of the first eccentric fastener 9a plus a predetermined horizontal adjustment range, i.e., the horizontal range by which the first hinge leaf 3a may be displaced with respect to the first element 2a. Specifically, the horizontal adjustment using the second eccentric fastener 9b in the vertical slot 4b produces horizontal shifts of the first hinge leaf 3a with respect to the first element 2a to the right by distance A (FIG. 3A) and to the left by distance B (FIG. 3B). Thus, the horizontal adjustment range of this illustrated embodiment is defined as A plus B. Similarly, the length dimension of the vertical slot 4b is at least the diameter of the circular head portion of the second eccentric fastener 9b plus a predetermined vertical adjustment range, which is a range by which the first hinge leaf 3a may be displaced with respect to the first element 2a.

As will be understood by those skilled in the art, referring to FIG. 3A, the horizontal adjustment range is twice the distance between an axis 19 of the head portion 10 and an axis 20 of the shaft portion 14 of the second eccentric fastener 9b. Likewise, the vertical adjustment range is twice the distance between an axis of the head portion 10 and an axis of the shaft portion 14 of the first eccentric fastener 9a. Thus, the adjustment range is determined by how much the shaft portion 14 is offset from the axial center of the fasteners 9a, 9b, or 9c. For example, if the shaft portion 14 is located 4 mm off-center, a total of 8 mm (+/−4 mm) adjustment is possible.

Accordingly, using the hinge system 1 of the present invention, when the first hinge leaf 3a is coupled to a door (or a door frame) and the second hinge leaf 3b is coupled to a door frame (or a door), a door installer can readily adjust the door within the door frame. The present invention allows for smooth and repeatable adjustment of the door with respect to the door frame in all three directions of motion. By adjusting each eccentric fastener separately, one may selectively adjust the door position three-dimensionally with respect to the door frame. Further, when more than one hinge system is used to couple the door to the door frame, each hinge system may be adjusted independently of the other hinges. As will be apparent to those skilled in the art, if more then one hinge system is used, the horizontal slot used for vertical adjustment in one hinge system may not be fitted with an eccentric fastener because the other hinge system including a horizontal slot fitted with an eccentric fastener would prevent vertical motion of the first hinge system, unless the eccentric fastener in the first hinge system is rotated at the same time and in the same orientation as the eccentric fastener in the second hinge system.

The present invention eliminates not only the risk of deforming either the door or the door frame during door installation but also the need to use complicated fixtures to support a door during installation. Instead, a door installer may couple the door (2a, for example) to the door frame (2b, for example) using only the hinge system 1 of the present invention, and then adjust the relative position of the door and the door frame. Once the door and the door frame are desirably positioned with respect to each other, suitable permanent fastening means, such as the bolts 6 through the oversized holes 5 described above, may be used to fixate the hinge leaves 3a, 3b to the door or the door frame.

While the preferred embodiments of the invention have been illustrated and described, it will be appreciated that various changes can be made therein without departing from the spirit and scope of the invention. For example, slots 4a, 4b, 4c may be provided through the first and second elements 2a, 2b, instead of through the first and second hinge leaves 3a, 3b, and still allow for the same adjustment of the relative position of the first and second elements 2a and 2b. As another example, the head of eccentric fasteners 9a, 9b, 9c may have a shape other than round, such as hexagon, octagon, or oval, as long as the rotation of the head within a slot is translated into vertical or horizontal movement of the slot. When the head shape is not circular, the rate of horizontal and vertical adjustments may differ accordingly from the adjustments achievable using a circular head, as will be apparent to those skilled in the art.

The embodiments of the invention in which an exclusive property or privilege is claimed are defined as follows:

1. An adjustable hinge system for coupling a first element to a second element, comprising:
a first hinge leaf defining a horizontal slot and a vertical slot, the horizontal and vertical slots extending orthogonally with each other, the first hinge leaf being adapted to be coupled to the first element;
a second hinge leaf pivotally coupled to the first hinge leaf, the second hinge leaf being adapted to be coupled to the second element;
a first eccentric fastener including a head portion and a shaft portion that extends off-axis from the head portion, the head portion being sized to be fitly received in the horizontal slot; and
a second eccentric fastener including a head portion and a shaft portion that extends off-axis from the head portion, the head portion being sized to be fitly received in the vertical slot;
wherein when the first hinge leaf is coupled to the first element by the first eccentric fastener extending through the horizontal slot into the first element, with its head portion being fitly received within the horizontal slot and the shaft portion being received in the first element, and by the second eccentric fastener extending through the vertical slot into the first element, with its head portion being fitly received within the vertical slot and the shaft portion being received in the first element, turning the head portion of the first eccentric fastener causes the vertical movement of the first hinge leaf relative to the first element, and turning the head portion of the second eccentric fastener causes the horizontal movement of the first hinge leaf relative to the first element.

2. The system of claim 1, wherein the second hinge leaf defines a second vertical slot, further comprising:
a third eccentric fastener including a head portion and a shaft portion that extends off-axis from the head portion, the head portion being sized to be fitly received in the second vertical slot;
wherein when the second hinge leaf is coupled to the second element by the third eccentric fastener extending through the second vertical slot into the second element, with its head portion being fitly received within the second vertical slot and the shaft portion being received in the second element, turning the head portion of the third eccentric fastener causes the horizontal movement of the second hinge leaf relative to the second element.

3. The system of claim 1, wherein the first and second elements are a door and a door frame or a door frame and a door, respectively.

4. The system of claim 1, wherein each of the horizontal and vertical slots includes a length dimension and a width dimension and the head portion of each eccentric fastener is generally circular, the width dimension of each slot is sized to generally match the diameter of the head portion of the corresponding eccentric fastener, the length dimension of the horizontal slot is at least the diameter of the head portion of the first eccentric fastener plus a predetermined horizontal adjustment range, and the length dimension of the vertical slot is at least the diameter of the head portion of the second eccentric fastener plus a predetermined vertical adjustment range.

5. The system of claim 4, wherein the horizontal adjustment range is twice the distance between an axis of the head portion and an axis of the shaft portion of the second eccentric fastener, and the vertical adjustment range is twice the distance between an axis of the head portion and an axis of the shaft portion of the first eccentric fastener.

6. A method of adjusting the relative position of first and second elements that are pivotally coupled together with a hinge, the hinge including a first hinge leaf coupled to the first element and a second hinge leaf coupled to the second element, the method comprising:
defining a horizontal slot and a vertical slot either through the first element or through the first hinge leaf, the horizontal and vertical slots extending orthogonally with each other;
providing a first eccentric fastener including a head portion and a shaft portion that extends off-axis from the head portion, the head portion being sized to be fitly received in the horizontal slot;
providing a second eccentric fastener including a head portion and a shaft portion that extends off-axis from the head portion, the head portion being sized to be fitly received in the vertical slot;
coupling the first hinge leaf and the first element by extending the first eccentric fastener through the horizontal slot, with its head portion being fitly received within the horizontal slot and the shaft portion being received in either the first element or the first hinge leaf that does not define the horizontal slot;
coupling the first hinge leaf and the first element by extending the second eccentric fastener through the vertical slot, with its head portion being fitly received within the vertical slot and the shaft portion being received in either the first element or the first hinge leaf that does not define the vertical slot;
turning the head portion of the first eccentric fastener within the horizontal slot to cause the vertical movement of the first hinge leaf relative to the first element; and
turning the head portion of the second eccentric fastener within the vertical slot to cause the horizontal movement of the first hinge leaf relative to the first element.

7. The method of claim 6, further comprising:
defining a second vertical slot either through the second element or through the second hinge leaf;
providing a third eccentric fastener including a head portion and a shaft portion that extends off-axis from the head portion, the head portion being sized to be fitly received in the second vertical slot;
coupling the second hinge leaf and the second element by extending the third eccentric fastener through the second vertical slot, with its head portion being fitly received within the second vertical slot and the shaft portion being received in either the second element or the second hinge leaf that does not define the second vertical slot; and
turning the head portion of the third eccentric fastener within the second vertical slot to cause the horizontal movement of the second hinge leaf relative to the second element.

8. The method of claim 6, wherein the first and second elements are a door and a door frame or a door frame and a door, respectively.

9. The method of claim 6, wherein each of the horizontal and vertical slots includes a length dimension and a width dimension and the head portion of each eccentric fastener is generally circular, the width dimension of each slot is sized to fitly receive the head portion of a corresponding eccentric fastener, the length dimension of the horizontal slot is at least the diameter of the head portion of the first eccentric fastener plus a predetermined horizontal adjustment range, the length dimension of the vertical slot is at least the diameter of the head portion of the second eccentric fastener plus a predetermined vertical adjustment range.

10. The system of claim 9, wherein the horizontal adjustment range is twice the distance between an axis of the head portion and an axis of the shaft portion of the second eccentric fastener, and the vertical adjustment range is twice the distance between an axis of the head portion and an axis of the shaft portion of the first eccentric fastener.
